(19) United States
(12) Patent Application Publication
(10) Pub. No.: US 2020/0011116 A1
(43) Pub. Date: Jan. 9, 2020

(54) POCKET DOOR FRAME

(71) Applicant: GREGORY ALAN WILK, PUNTA GORDA, FL (US)

(72) Inventor: GREGORY ALAN WILK, PUNTA GORDA, FL (US)

(21) Appl. No.: 16/503,538

(22) Filed: Jul. 4, 2019

Related U.S. Application Data
(60) Provisional application No. 62/695,757, filed on Jul. 9, 2018.

(51) Int. Cl. E06B 3/46; E06B 1/20; E06B 1/52

(52) U.S. Cl. CPC E06B 3/4654; E06B 1/52; E06B 1/20

(57) ABSTRACT

A pocket door frame that is foldable for easier transport and takes up less space to store. The pocket door includes upper portions and lower portions that are horizontally orientated in use and that can be adjusted in width to allow the single pocket door frame to be used for several different pocket door widths. In a preferred embodiment, the various parts that comprise the pocket door frame and attachable upright members are constructed from a galvanized steel material having an anticorrosion coating to eliminate problems often experienced with wooden pocket door frames.

This application claims the benefit of and priority to U.S. Application Ser. No. 62/695,757, file Jul. 9, 2018, which application is incorporated by reference in its entirety for all purposes.

### 1. FIELD OF THE DISCLOSURE

The disclosure relates generally to door frames and more particularly to pocket door frames.

### 2. BACKGROUND

Pocket door frames that are made from wood are known to decay, hold moister and are not easily transported to job sites and are often damaged during transit. With wooden pocket door frames water and termite damage is also possible. Warping issues are also known to occur. The pocket door frame is typically provided for a specific sized pocket door. As the there are several different door sizes on the market, this causes a building supply house to carry and inventory several different sizes of pocket door widths and corresponding pocket door frames.

The disclosed novel pocket door frame is addressed to reducing, if not eliminated, the above noted issues with current pocket doors and pocket door frames.

### SUMMARY OF THE DISCLOSURE

A novel pocket door frame is generally disclosed and can be preferably foldable for easier transport and to take up less space in transit or storage. When assembled, the pocket door includes upper portions and lower portions that are unfolded to horizontal orientations in use and which can be adjusted in width to allow the single pocket door frame to be used for several different pocket door width. A plurality of uprights member help to maintain the horizontal orientations/positions of the upper and lower portions, as well as the maintaining the selected width for the novel pocket door frame.

The disclosed novel pocket door frame preferably allows an end user/installer to choose from a plurality of pocket door widths and heights for the pocket door frame. Thus, one frame can be configured for several different widths/heights and avoids having to have multiple pocket door frames (i.e. one for each width) in storage. In one non-limiting embodiment, the width options can include pocket door widths of 24″, 28″, 30″, 32″ and 36″. However, the disclosure is not limited to any particular width dimensions. The selected height for the pocket door frame can be decided by the length of the uprights secured to the door frame and the length of the extended vertically orientated U-channel member of the door frame. In one non-limiting embodiment, the lengths of the uprights and extended U-channel can be 6′8″, 7′0″ and 8′0″. However, the disclosure is not limited to any particular height dimensions.

Preferably, the four uprights are field installed (i.e. at the jobsite), preferably after the novel pocket door frame has been unfolded and the desired width selected through the positioning of the top and bottom components/parts of the pocket door frame with respect to each other through slidable securements. Screws can be used to attach the uprights, along with conventional sliding track and hardware such as, but not limited to, tracks and hardware manufactured by JOHNSON and JELDWEN.

In a preferred embodiment, the various parts that comprise the pocket door frame and attachable upright members are constructed from a metal material and preferably a galvanized steel having an anticorrosion coating to reduce, if not eliminate, problems often experienced with pocket door frames made from wood. Other materials can also be used and are considered within the scope of the disclosure.

The disclosed novel metal foldable and width/height adjustable pocket door frame makes it easier to transport the pocket door frame to the jobsite as compared to conventional pocket door frame and also reduces the chance of damage to the pocket door frame during transit that is common with wooden pocket door frames. Water and termite damage is also significantly reduced, if not eliminated through use of the disclosed pocket door frame. Warping issues found with wooden pocket door frames is also eliminated with the use of the novel disclosed pocket door frame.

The disclosed novel pocket door frame is able to fold up and easy to install and when folded preferably can fit inside a box (i.e. reinforced cardboard box, etc.) approximately 8′ long by 10″ high by 10″ deep. The disclosed pocket door frame preferably does not rust or warp and can be straighter and squarer as compared to conventional pocket door frames. In storage, the disclosed pocket door frame, by being foldable, will take up a significantly less amount of space as current wooden pocket door frame that are stored assembled. With significantly less wood involved with the disclosed novel pocket door frame (i.e. trim, door, as opposed to the frame as well like with current frames) less fire hazard concerns are involved and the expense of using a fire-retardant wood for the frame is eliminated.

Thus, disclosed is a novel folding, adjustable metal pocket door frame preferably provided with slidable adjustments to different width dimensions and foldable for compact transit and storage.

### BRIEF DESCRIPTION OF THE DRAWINGS

FIG. 1 is a front view of the novel pocket door frame with uprights shown in a fully assembled and unfolded position in accordance with the present disclosure;

FIG. 2 is a perspective view of the novel pocket door frame with uprights shown in a folded position in accordance with the present disclosure;

FIG. 3 a perspective partially exploded view of the novel pocket door frame with uprights in a folded position in accordance with the present disclosure;

FIG. 4 is another perspective partially exploded view of the novel pocket door frame with uprights in a folded position in accordance with the present disclosure;

FIG. 5 is a front view of the novel pocket door frame in a partially unfolded position in accordance with the present disclosure;

FIG. 6 is another front view of the novel pocket door frame in a partially unfolded position in accordance with the present disclosure;

FIG. 7 is a perspective view of the novel pocket door frame in a partially unfolded position in accordance with the present disclosure;

FIG. 8 is a front view of the novel pocket door frame shown in a fully unfolded position in accordance with the present disclosure;

FIG. 9 is another front view of the novel pocket door frame shown in a fully unfolded position in accordance with the present disclosure;

FIG. 10 is a perspective view of the novel pocket door frame shown in a fully unfolded position in accordance with the present disclosure;

FIG. 11 is another front view of the novel pocket door frame with uprights shown in a fully assembled and unfolded position and shown in accordance with the present disclosure;

FIG. 12 is a perspective view of the novel pocket door frame with uprights shown in a fully assembled and unfolded position in accordance with the present disclosure;

FIG. 13 is another front view of the novel pocket door frame with uprights shown in a fully assembled and unfolded position and shown for use with a first door width size in accordance with the present disclosure;

FIG. 14 is another front view of the novel pocket door frame with uprights shown in a fully assembled and unfolded position and shown for use with a second door width size in accordance with the present disclosure;

FIG. 15 is another front view of the novel pocket door frame with uprights shown in a fully assembled and unfolded position and shown for use with a third door width size in accordance with the present disclosure;

FIG. 16 is another front view of the novel pocket door frame with uprights shown in a fully assembled and unfolded position and shown for use with a fourth door width size in accordance with the present disclosure;

FIG. 17 a top perspective partial view of the novel pocket door frame with uprights in a fully assembled and unfolded position in accordance with the present disclosure;

FIG. 18 is bottom perspective partial view of the novel pocket door frame with uprights in a fully assembled and unfolded position in accordance with the present disclosure;

FIG. 19 is a perspective view of hat channel of the novel pocket door frame in accordance with the present disclosure;

FIG. 20 is a side elevational view of the hat channel of FIG. 19;

FIG. 21 is a perspective view of a modified hat channel of the novel pocket door frame in accordance with the present disclosure;

FIG. 22 is a side elevational view of the modified hat channel of FIG. 21;

FIG. 23 is a perspective view of a U-channel of the novel pocket door frame in accordance with the present disclosure;

FIG. 24 is a side elevational view of the U-channel of FIG. 23;

FIG. 25 is a perspective view of a first upright member of the novel pocket door frame in accordance with the present disclosure;

FIG. 26 is a side elevational view of the first upright member of FIG. 25;

FIG. 27 is a perspective view of a second upright member of the novel pocket door frame in accordance with the present disclosure;

FIG. 28 is a side elevational view of the second upright member of FIG. 27;

FIG. 29 is a perspective view of an elongated or extended U-channel of the novel pocket door frame in accordance with the present disclosure;

FIG. 30 is a side elevational view of the elongated or extended U-channel of FIG. 29;

FIG. 31 is a perspective view of a shorter length U-channel of the novel pocket door frame in accordance with the present disclosure;

FIG. 32 is a side elevational view of the shorter length U-channel of FIG. 31;

FIG. 33 is a perspective view of a further shorter length U-channel of the novel pocket door frame in accordance with the present disclosure;

FIG. 34 is a side elevational view of a further shorter length U-channel of FIG. 33;

FIG. 35 is a perspective underneath view illustrating a non-limiting sliding/slider track that can be used for securing the pocket door for the novel pocket door frame in accordance with the present disclosure;

FIG. 36 is a closeup perspective view illustrating the slidable/adjustable securement of the hat channel at the first end of the modified hat channel for the novel pocket door frame in accordance with the present disclosure;

FIG. 37 is a closeup perspective view illustrating the securement of the upright member to an intermediate point of the modified hat channel for the novel pocket door frame in accordance with the present disclosure; and

FIG. 38 is closeup perspective view of another upright member to the end of the modified hat channel and also showing the slidable/adjustable securement of the modified hat channel and the U-channel.

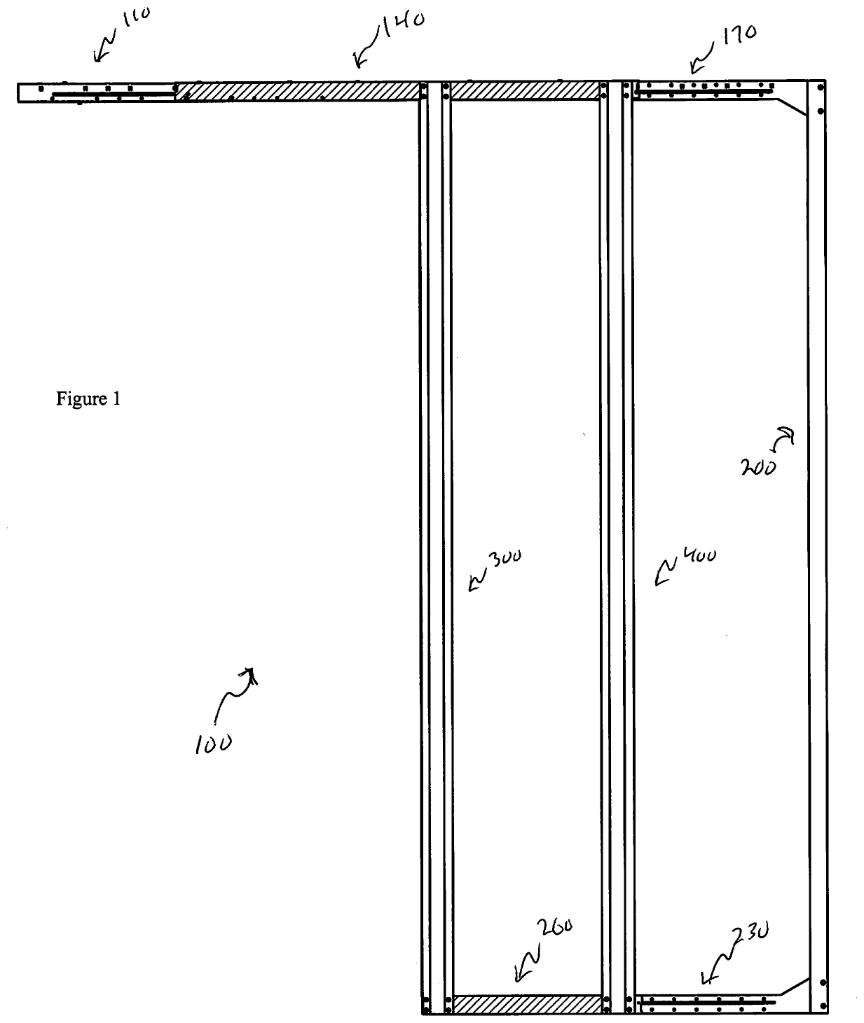

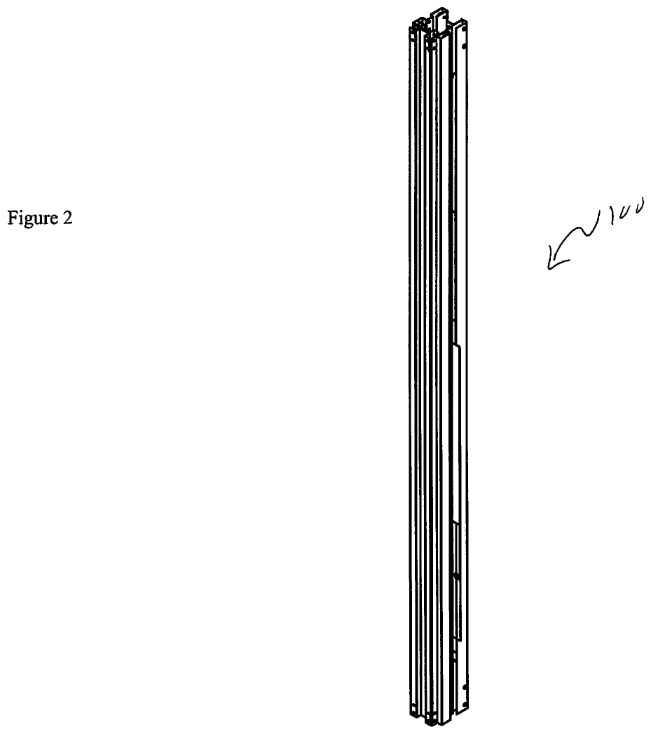

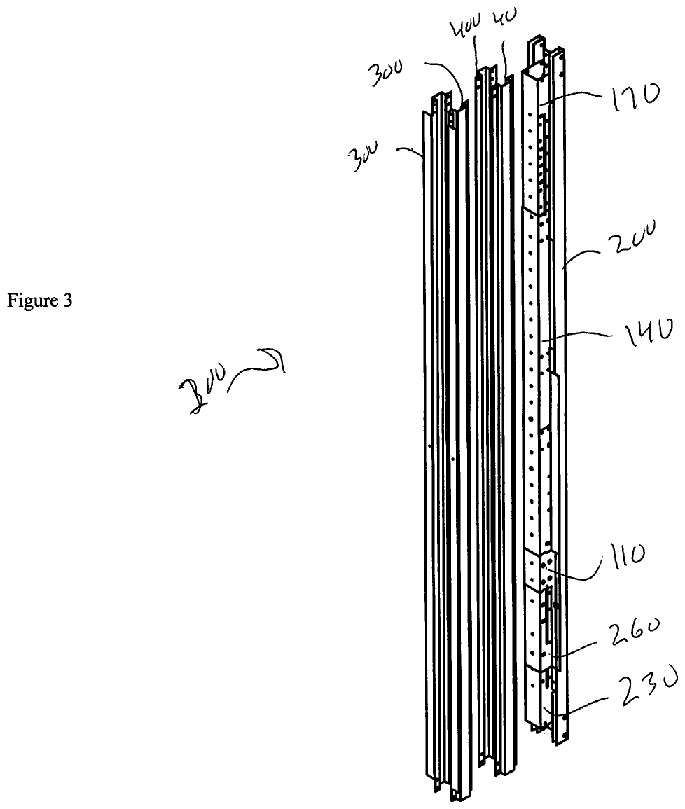

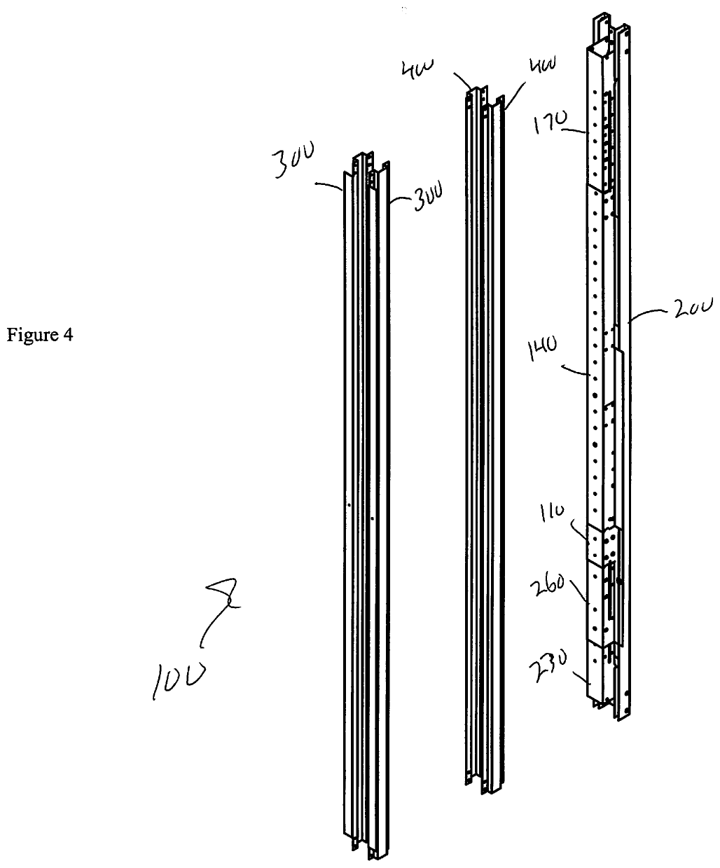

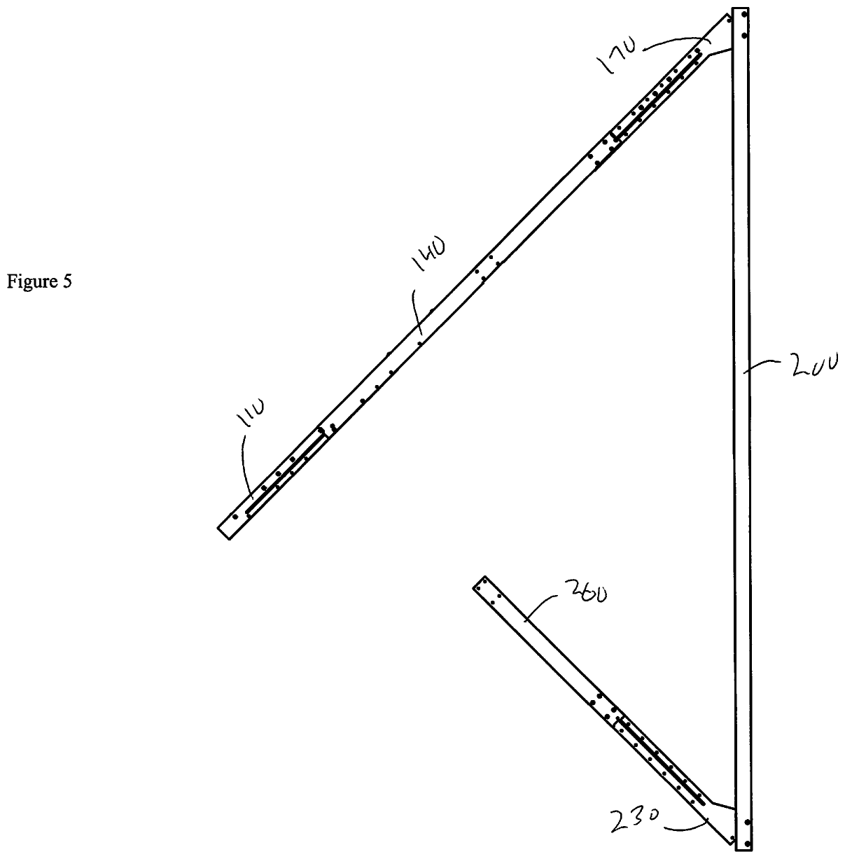

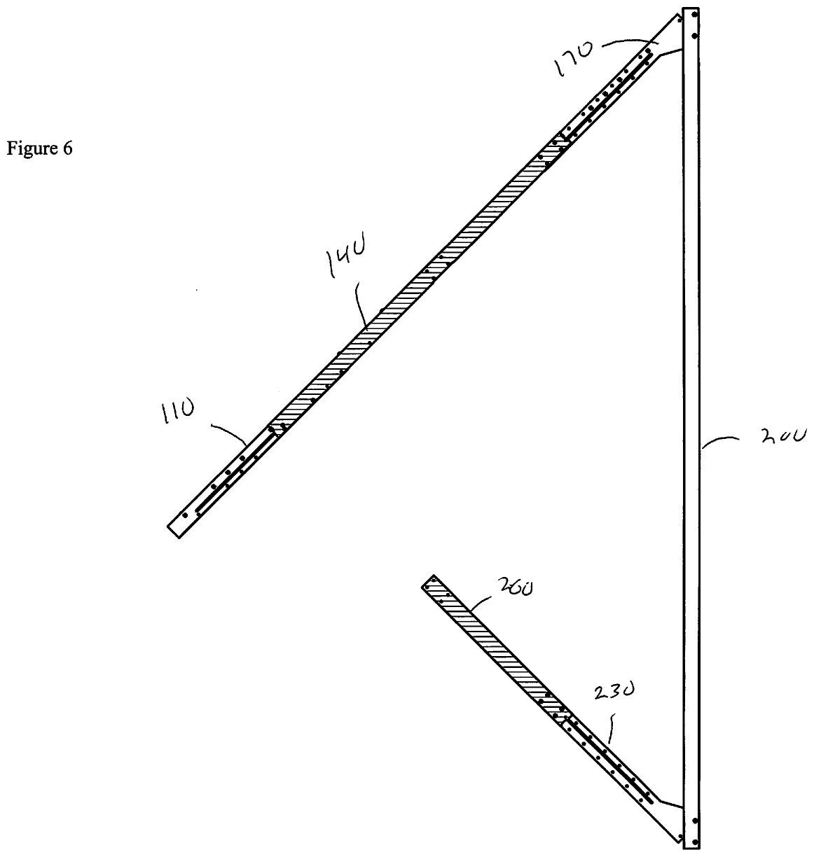

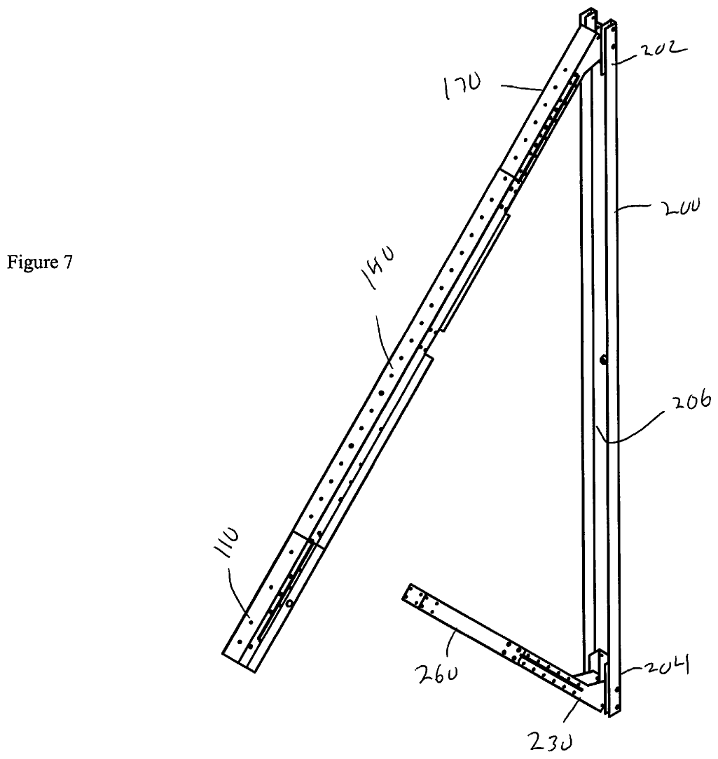

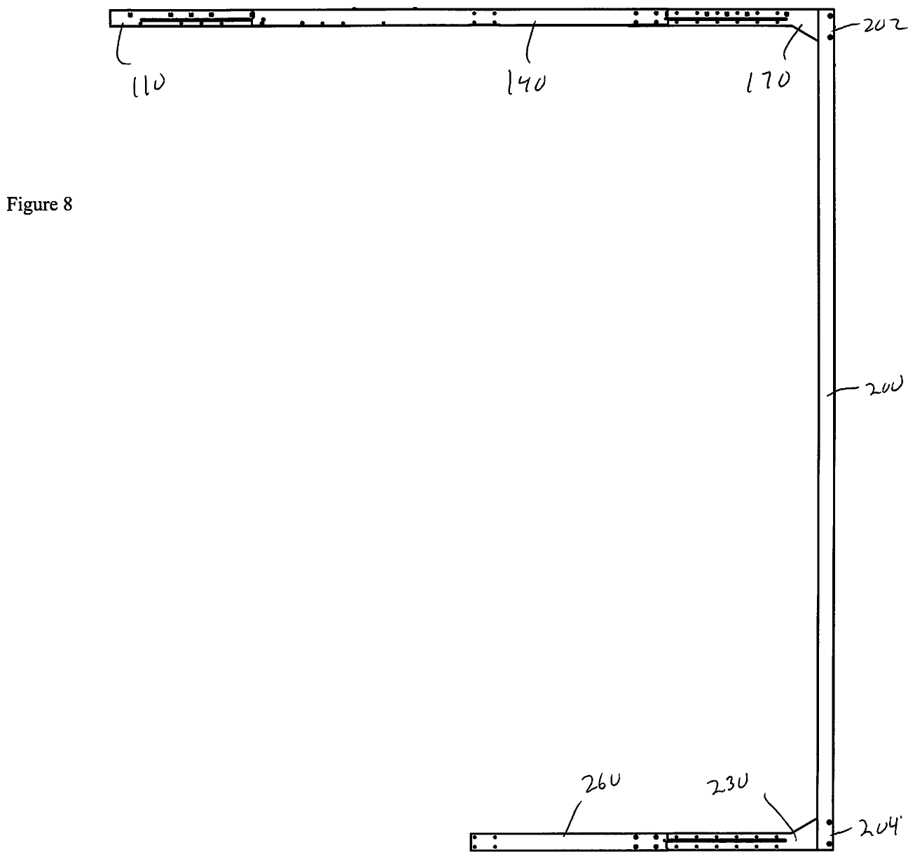

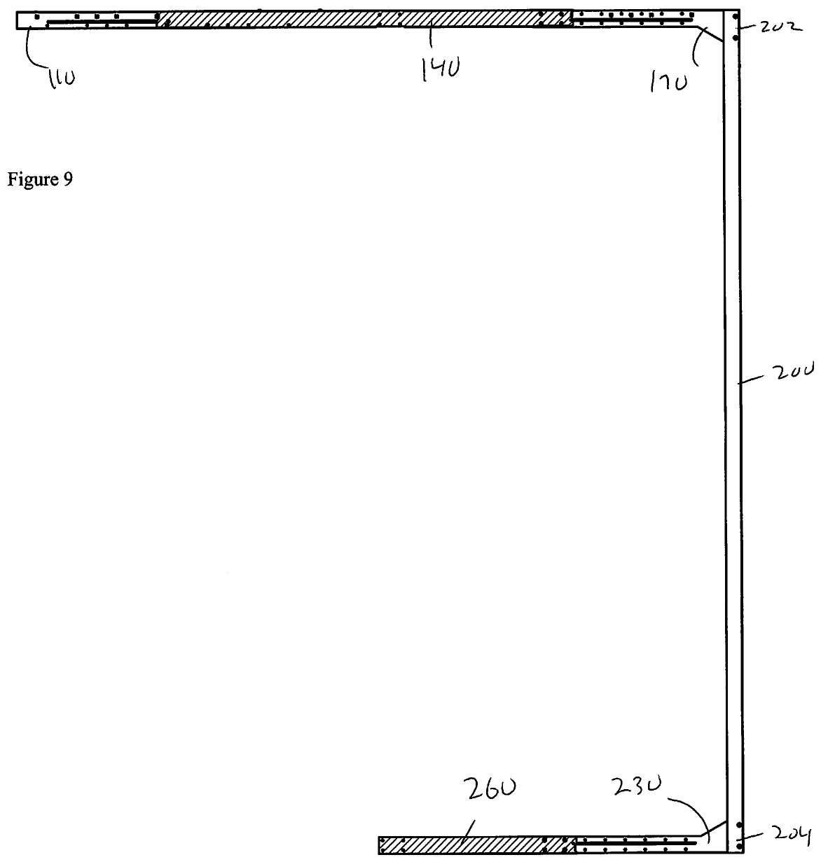

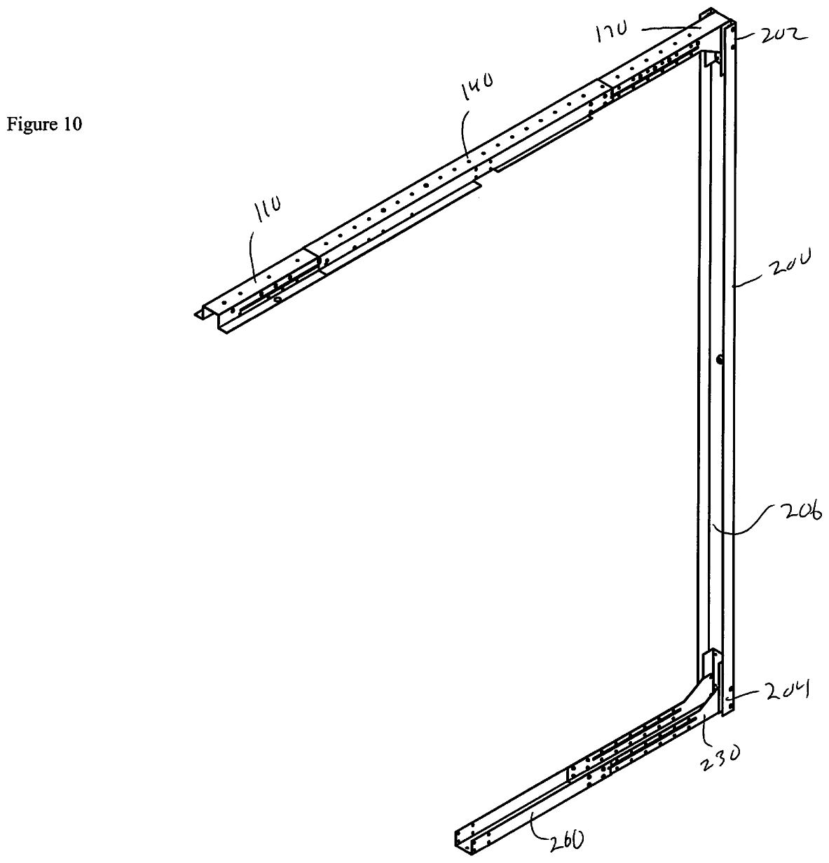

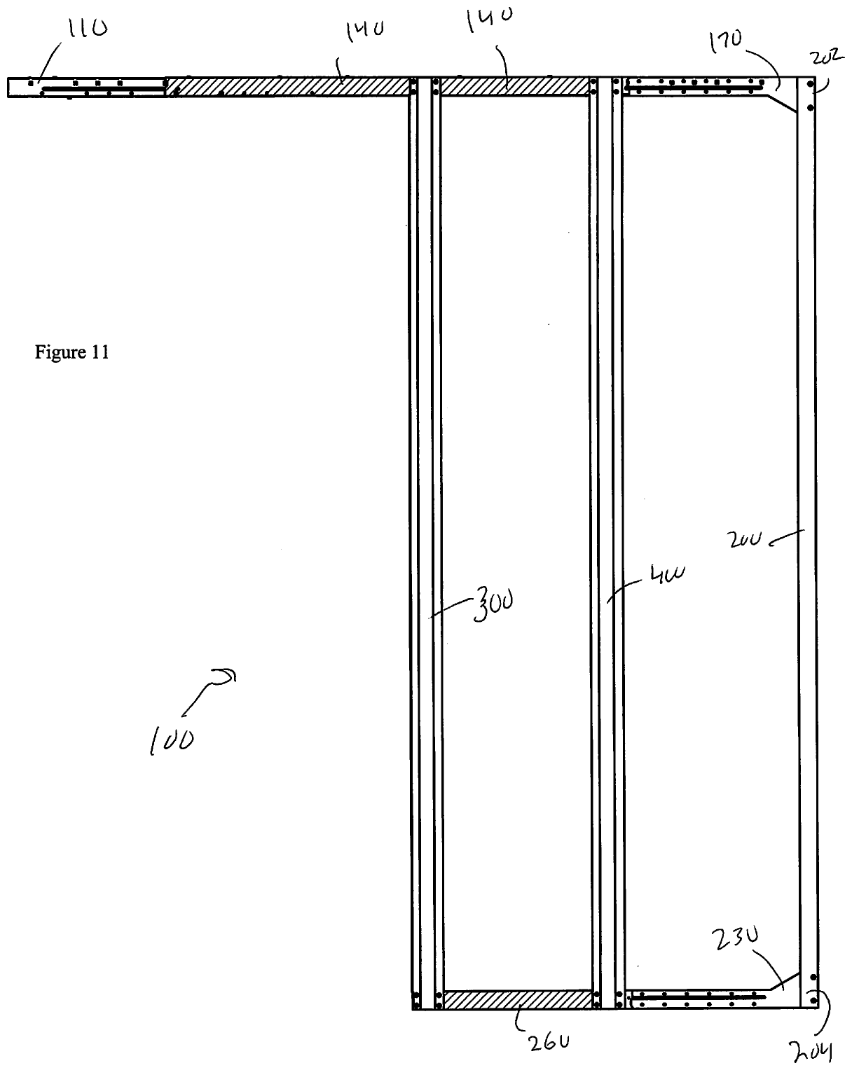

### DETAILED DESCRIPTION

As seen in the figures a novel pocket door frame and uprights is shown and described in detail above and below and generally disclosed as pocket door frame 100 and uprights 300 and 400. Pocket door frame 100 preferably comprises a first hat channel 110, a modified hat channel 140, a U-channel 170, an extended length U-channel 200, a second U-channel 230 and a third U-channel 260.

Modified hat channel 140 can be preferably slidably connected with first hat channel 110 at a first end 142 of modified hat channel 140. U-channel 170 can be preferably slidably connected to a second end 144 of modified hat channel 140. Extended length U-channel 200 can have a first end 202 and a second end 204 and can be preferably rotatably connected to U-Channel 170 (i.e. first end 172 of the U-channel 170 and first end 202 of U-channel 200. Second U-channel 230 can be preferably rotatably connected to extended U-channel 200 at second end 204 of U-channel 200. Third U-channel 260 can be preferably slidably connected with second U-channel 230.

First hat channel 110 comprises a first end 112 and a second end 114 and includes a central U-shaped member 116 having a top portion 118, a first side portion 120, a second side portion 122, a first flange 124 extending outward from first side portion 120 at or approximately at a 90 degree angle and a second flange 126 extending outward from second side potion 122 at or approximately at a 90 degree angle. A first slot 128 can be provided in a portion of first side portion 120 and a second slot 130 can be provided in a portion of second side portion 122. A channel or passageway 115 can preferably extend from first end 112 to second end 114.

Slots 128 and 130, in connection with inner rivets and protrusions of modified hat channel 140, are used for slidably connecting first hat channel 110 to modified hat channel 140. Though preferably two slots 128 and 130 (with corresponding rivers/protrusions) are provided, it is within the scope of the disclosure to provide a single slot 128 or 130 on one side of central U-shaped member 116. Also a plurality of apertures 131 can be provided on at least one side of central U-shaped member 116. A top row of apertures or markings 132 can be used as a guide for door width selections and depending on the door width selections aligns one or more apertures from a bottom row of apertures 133 with apertures of modified hat channel 140 to allow screws to be inserted through the aligned apertures for maintaining the positional relationship between first hat channel 110 and modified hat channel 140 based on the selected door with. It is also within the scope of the disclosure to use a top row of apertures on the sidewall of hat channel 110 for alignment with apertures of the modified hat channel 140 and a bottom row of apertures or markings on the sidewall of hat channel 110 as the width guide.

Top portion 118 can also be provided with a plurality of aperture 134 that can be aligned with top apertures 154 extending along a top portion 153 of modified hat channel 140. Screw(s) can be inserted through one or more of these aligned apertures (134 and 154) as a further way of maintaining the positional relationship between hat channel 110 and modified hat channel 140. In addition or in lieu of these screws, the attaching portion of the door tracks (i.e. standard JOHNSON tracks, etc.) can be inserted in one or more of the aligned apertures when installing the door track within channel/passageway 115 of first hat channel 110 and channel/passageway 145 of modified hat channel 140 and such installment can also serve the purpose of also maintaining the positional relationship between first hat channel 110 and modified hat channel 140 for the selected door width size.

Modified hat channel 140 includes a first end 142 and a second end 144 and a channel or passageway 145 which can extend from first end 142 to second end 144. Modified hat channel 140 comprises a monolithically form hat channel member 146 associated with first end 142 and U-channel portion 148 associated with second end 144. Hat channel member 146 can be shaped similar to first hat channel 110, but preferably without slots like slots 128 and 130, as well as preferably without a top row of apertures like apertures 132.

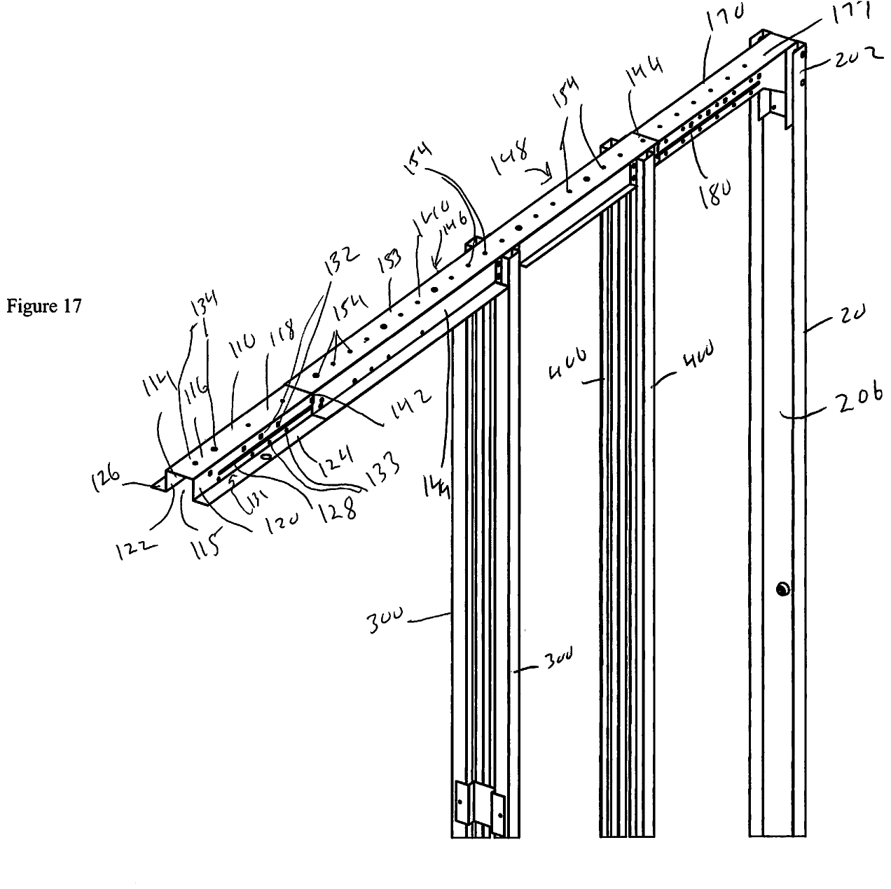

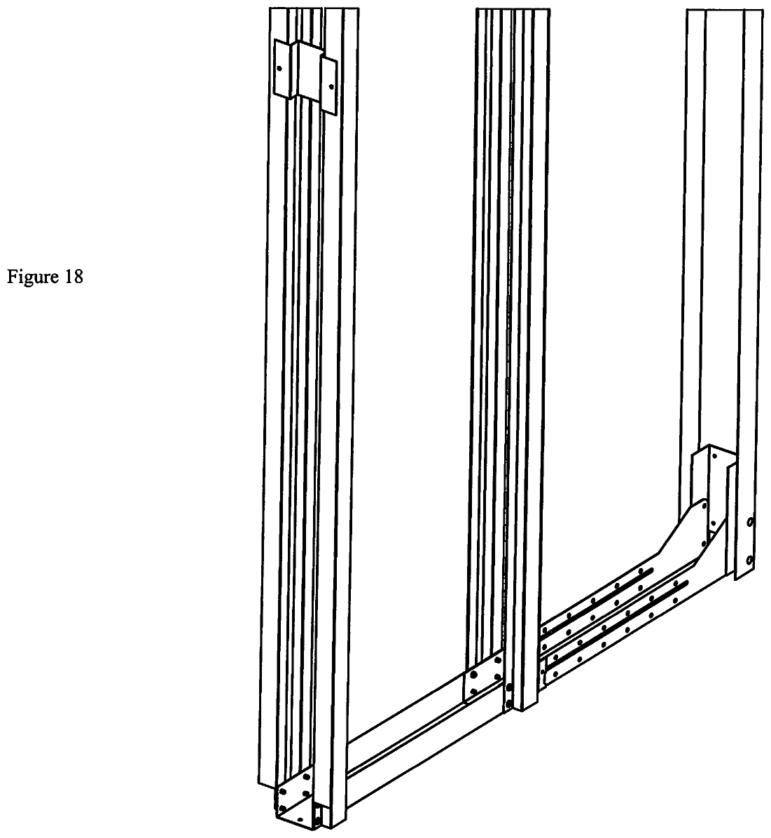

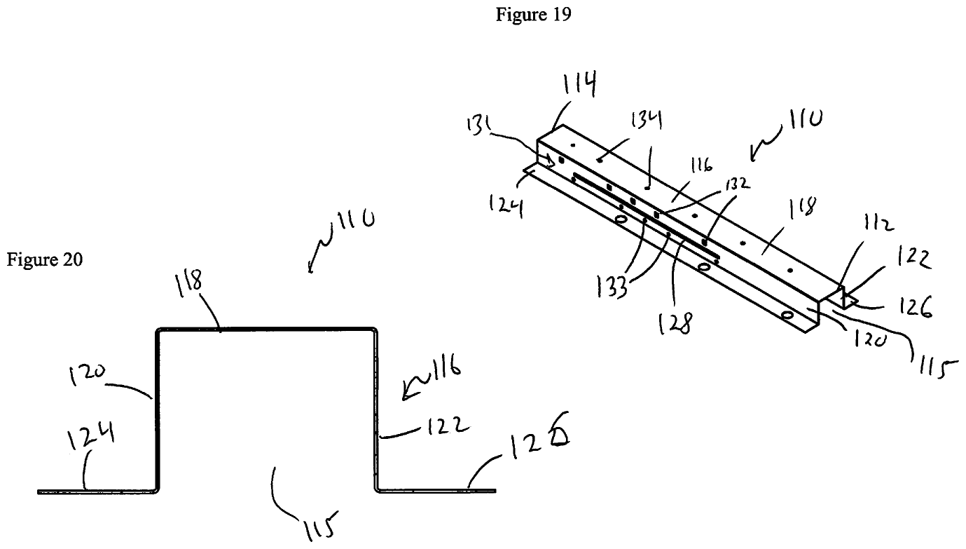

At the inner end of hat channel member 146 (i.e. middle of modified hat channel 140) one or more apertures 147 can be preferably provided (i.e. shown as four apertures in a square pattern—though not considered limiting) in side wall 150. Opposite side wall 149 can be also preferably provided with a plurality of apertures at a same location along modified hat channel 140, which preferably can be in the same aperture pattern as apertures 147. Apertures 147 can be used for fastening a top end of uprights 300 (one upright 300 on each side) to modified hat channel 140 at or near its middle length location (see FIG. 17).

A second of apertures 152 can also be preferably provided in side walls 149 and 150 near second end 144 of modified hat channel 140. Preferably, the number and pattern of apertures 152 corresponds to the number and pattern of apertures/holes 147, though such is not considered limiting, and the number of holes/apertures and/or patterns between apertures 147 and apertures 152 can differ. Apertures 152 can be used for fastening a top end of uprights 400 (one upright 400 on each side) to modified hat channel 140 at or near its second end 144 (See FIG. 17).

Though not considered limiting, the inner rivet(s)/protrusions(s) 157 can be preferably located at or near first end 142 of channel/passageway 145 to allow for greatest amount of slidable length movement between first hat channel 110 and modified hat channel 140.

With the rivet/protrusion of modified hat channel 140 in their corresponding slots 128 and/or 130 of hat channel 110 and at least a portion of hat channel 110 (starting at first end 112) disposed within channel/passageway 145, hat channel 110 is slid with respect to modified hat channel 140 in order to also position hat channel 110 at the proper aperture of the top apertures 132 for the desired door width. Preferably the size of U-channel 116 of first hat channel 110 is slightly smaller than inner channel/passageway 145 of modified hat channel 140 to allow at least a portion of U-channel 116 to be received and disposed within channel/passageway 145 in use.

U-shaped member 148 of modified hat channel 140 can include apertures 152 at second end 144 and a portion of top apertures 154. Inner rivets/protrusions can also be provided within channel/passageway 145 in connection with U-shaped member 148 (similar to the inner rivet(s) 157 at one or more sides of channel 145 in connection with hat channel member 146. These inner rivet(s)/protrusions(s) can be preferably located at or near second end 144 of channel/passageway 145 to allow for greatest amount of slidable length movement between U-channel 170 and modified hat channel 140. Slots 180 and 182, in connection with these additional inner rivets and protrusions of modified hat channel 140 at second end 144, are used for slidably connecting U-channel 170 to modified hat channel 140. Though preferably two slots 180 and 182 (with corresponding rivers/protrusions) can be provided, it is within the scope of the disclosure to provide a single slot 180 or 182 on one side wall 173 Or 175 of U-channel 170. U-channel 170 can have a first end 171 and a second end 172 and a channel or passageway 187 extending from first end 171 to second end 172. First end 171 can be extended in size as compared to second end 172 and is pivotally connected to extended U-channel 200 at first end 202 of extended U-channel 200.

With the rivet/protrusion at second end 144 of modified hat channel 140 in their corresponding slots 180 and/or 182 of U-channel 170 and at least a portion of U-channel 170 (starting at first end 171) disposed within channel/passageway 145 at second end 144, U-channel 170 can be slid with respect to modified hat channel 140 in order to position/align the correct aperture(s) 186 along the sidewalls 173 and/or 175 of U-channel 170 (i.e. based on the door width selected) with aperture(s) 152 located at second end 144 of modified hat channel 140. As such, the securement of the top end of uprights 400 (by aligning the apertures at the top end with aligned apertures 152 and apertures 186) will maintain the positional relationship between modified hat channel 140 and U-channel 170, while also helping in assisting with the preferred 90-degree “in use” relationship between U-channel 170 and extended U-channel 200. This sliding movement can also position some of top apertures 154 of modified hat channel 140 with some of one or more of top apertures 184 in top wall 177 of U-channel 170.

Screw(s) can be inserted through one or more of these aligned apertures (154 and 184) as a further way of maintaining the positional relationship between modified hat channel 140 and U-channel 170. In addition or in lieu of these screws, the attaching portion of the door tracks (i.e. standard JOHNSON tracks, etc.) can be inserted in one or more of the aligned apertures when installing the door track within channel/passageway 187 of U-channel 170 and channel/passageway 145 of modified hat channel 140 and such installment can also serve the purpose of also maintaining the positional relationship between U-channel 170 and modified hat channel 140 for the selected door width size.

Preferably the size of U-channel 170 is slightly smaller than inner channel/passageway 145 of modified hat channel 140 to allow at least a portion of U-channel 170 to be received and disposed within channel/passageway 145 in use.

Extended U-channel 200 can include a first end 202 and a second end 204 and a channel/passageway 206 extending from first end 202 to second end 202. A first set of apertures 210 can be provided (preferably on both sides of first end 202) for alignment with apertures 190 at enlarged second end 172 of U-channel 170 to allow for a pivot connection (i.e. rivet/bolt/screw, etc. through apertures 190 and 210) of U-channel 170 with extended U-channel 200 at first end 202 of extended U-channel. Similarly, a second set of apertures 214 can be provided (preferably on both sides of second end 204) for aligned with apertures 240 of enlarged second end 232 of a second U-channel 230 to allow for a pivot connection (i.e. rivet/bolt/screw, etc. through apertures 214 and 240) of second U-channel 230 with extended U-channel 200 at second end 204 of extended U-channel 200.

Second U-channel 230 can be physically similar to U-channel 170 and can have a first end 231 and a second end 232 and a channel or passageway 247 extending from first end 231 to second end 232. Second end 232 can be extended in size as compared to first end 231 and second end 232 can be pivotally connected to extended U-channel 200 at second end 204 of extended U-channel 200. First end 231 of second U-channel 230 can be slidably connected to third U-channel 260, through a similar slidable connection as U-channel 170 and U-channel portion 148 of modified hat channel 140.

U-shaped member 260 can include a first end 262 and a second end 264 and can have channel/passageway 263 extending from first end 262 to second end 264. At first end 262 one or more apertures 267 (preferably similar to apertures 152) can be provided (i.e. shown as four apertures in a square pattern—though not considered limiting) in side wall 270. Opposite side wall 271 can be also preferably provided with a plurality of apertures at first end 262, which preferably can be in the same aperture pattern as apertures 267. Apertures 267 can be used for fastening a bottom end of uprights 400 (one upright 400 on each side) to U-shaped member 260 at or near its first end 262.

A second of apertures 269 (preferably similar to apertures 147) can also be preferably provided in side walls 270 and 271 near second end 264 of U-shaped member 260. Preferably, the number and pattern of apertures 269 corresponds to the number and pattern of apertures/holes 267, though such is not considered limiting, and the number of holes/apertures and/or patterns between apertures 267 and apertures 269 can differ. Apertures 269 can be used for fastening a bottom end of uprights 300 (one upright 300 on each side) to U-shaped member 260 at or near its second end 264.

Inner rivets/protrusions can also be provided within channel/passageway 263 preferably at or near first end 262 (similar to the inner rivet(s)/protrusions at second end 144 of channel 145 of modified hat channel 140). These inner rivet(s)/protrusions(s) can be preferably located at or near first end 262 of channel/passageway 263 to allow for greatest amount of slidable length movement between U-shaped member 260 and second U-channel 230. Slots 250, in connection with the inner rivets and protrusions of U-shaped member 260 near first end 262, are used for slidably connecting U-channel 230 to U-shaped member 260. Though preferably two slots 250 (with corresponding rivers/protrusions) can be provided, it is within the scope of the disclosure to provide a single slot 250 on one side wall 241 or 243 of second U-channel 230.

With the rivet/protrusion at first end 262 in their corresponding slots 250 of second U-channel 230 and at least a portion of second U-channel 230 (starting at first end 231) disposed within channel/passageway 263 at first end 262, second U-channel 230 can be slid with respect to U-shaped member 260 in order to position/align the correct aperture(s) 245 along the sidewalls 241 and/or 243 of second U-channel 230 (i.e. based on the door width selected) with aperture(s) 267 located at first end 262 of U-shaped member 260. As such, the securement of the bottom end of uprights 400 (by aligning the apertures at the bottom end with aligned apertures 267 and apertures 245) will maintain the positional relationship between U-shaped member 260 and second U-channel 230, while also helping in assisting with the preferred 90-degree “in use” relationship between second U-channel 230 and extended U-channel 200. This sliding movement can also position some of top apertures 271 of U-shaped member 260 with some of one or more of top apertures 253 in top wall 251 of second U-channel 230. It is also noted that preferably the alignment (door width selection) between modified hat channel 140 and U-channel 170 is the same as the alignment selection between U-shaped member 260 and second U-channel 230, to preferably allow for uprights 300 and uprights 400 to be connected parallel or substantially parallel with extended U-channel 200 and also form right angle connections with respect to the components they are secured to.

Screw(s) can be inserted through one or more of these aligned apertures (271 and 253) as a further way of maintaining the positional relationship between U-shaped member 260 and second U-channel 230. In addition or in lieu of these screws, the attaching portion of the door/slider tracks 550 (i.e. standard JOHNSON tracks, etc.) can be inserted in one or more of the aligned apertures when and if a door track is also installed channel/passageway 247 of second U-channel 230 and channel/passageway 263 of U-shaped member and such installment can also serve the purpose of also maintaining the positional relationship between second U-channel 230 and U-shaped member 260.

When transporting novel pocket door frame 100, U-channel 170 can be preferably pivotally folded inwards and positioned at least partially within channel/passageway 206 of extended U-channel 200, which causes the also secured modified hat channel 140 and first hat channel 110 to also be disposed and positioned partially within channel/passageway 206. Similarly, during transport of pocket door frame 100, second U-channel 230 can be pivotally folded inwards and positioned partially within channel/passageway 206, which causes the also secured third U-channel 260 to also be disposed and positioned partially within channel/passageway 206. Thus, pocket door frame 100 in its folded configuration can be compact in size, as opposed to current pocket door frame which are currently transported to a job site in an assembled configuration and thus consuming a much larger space during transport. Additionally, inventorying the disclosed novel frame 100 at a building supply location, also requires less space than conventional pocket door frames. Additionally, further space saving is also achieve with the novel described frame 100, as it is adjustable allowing one frame to be preferably used for several different pocket door width sizes, as opposed to having to have a plurality of frames with each frame assembled to a specific pocket door width.

Preferably, the height of the pocket door frame 100 can be varied and is not limited to any particular height. The chosen vertical height for frame 100 can be achieved by the length of extended U-channel 200, as well as uprights 300 and 400. Preferably, the length of extended U-channel 200, uprights 300 and uprights 400 are the same length. As non-limiting examples, standard pocket door heights, such as, 6′8″, 7′0″ and/or 8′0″ can be selected for frame 100, though other height dimensions, smaller or larger, can be chosen and are considered within the scope of the disclosure. Similar the pocket door widths selections discussed above can also be a plurality of standard pocket door widths to select from such as, without limitation, 2-0 (24″), 2-4 (28″), 2-6 (30″), 2-8 (32″) and/or 3-0 (36″), though other width dimensions, smaller or larger, can be chosen and are considered within the scope of the disclosure.

Preferably, the width selection chosen for the position relationship/connection point between first hat channel 110 and modified hat channel 140 is also the same width selection chosen for the position relationship/connection point between modified hat channel 140 and U-channel 170.

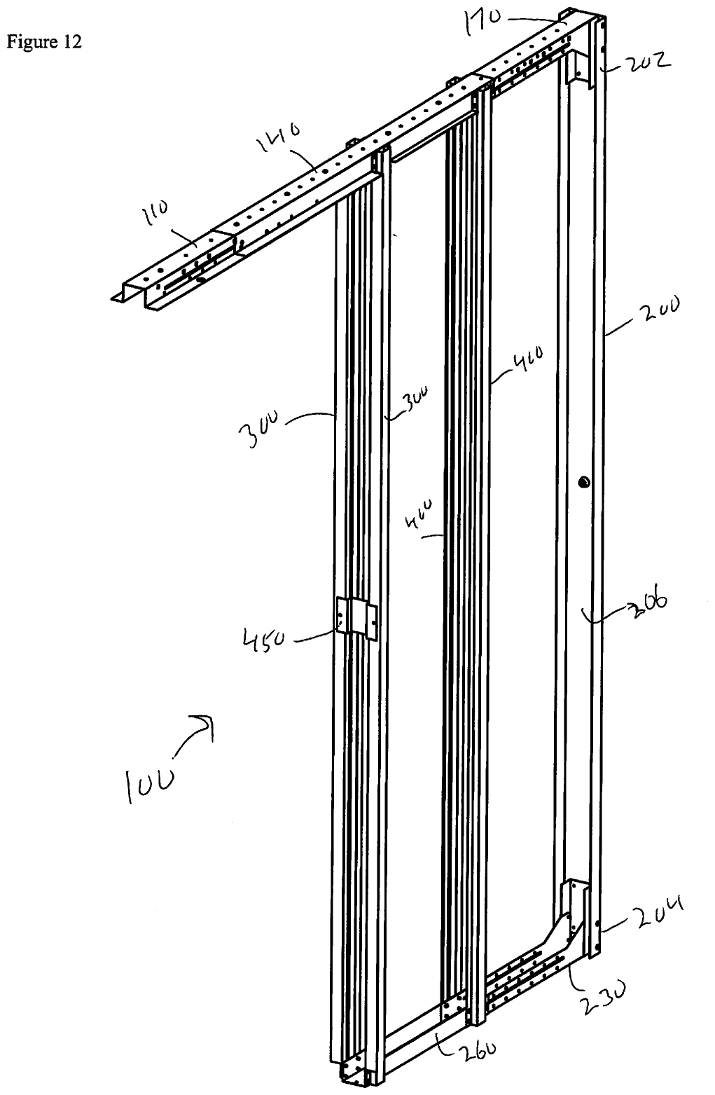

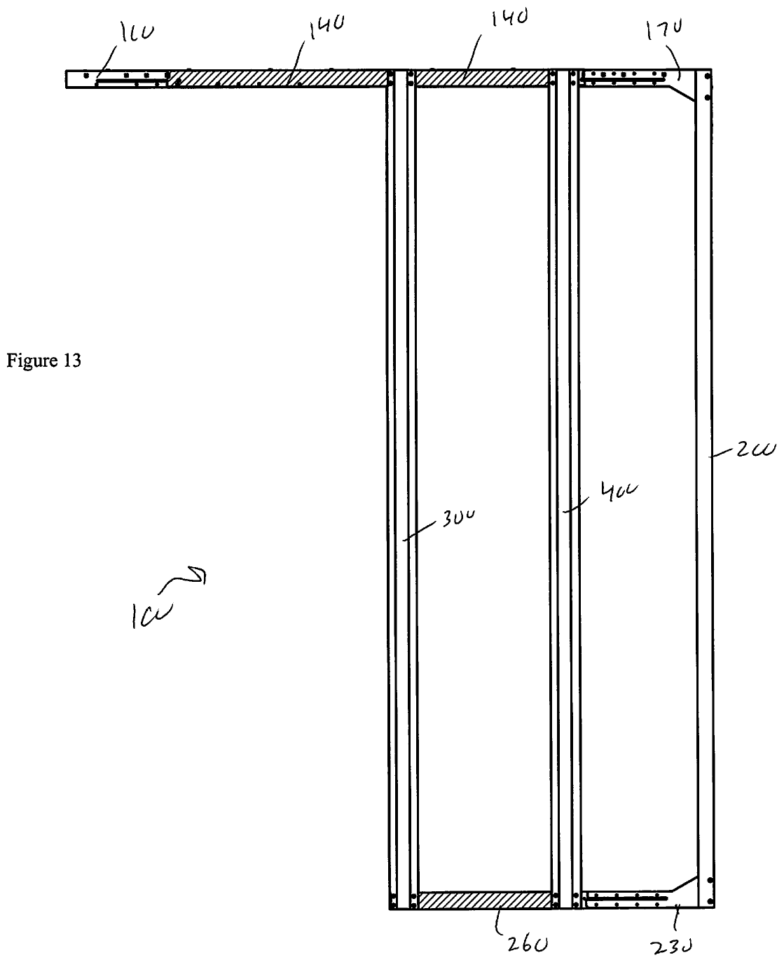

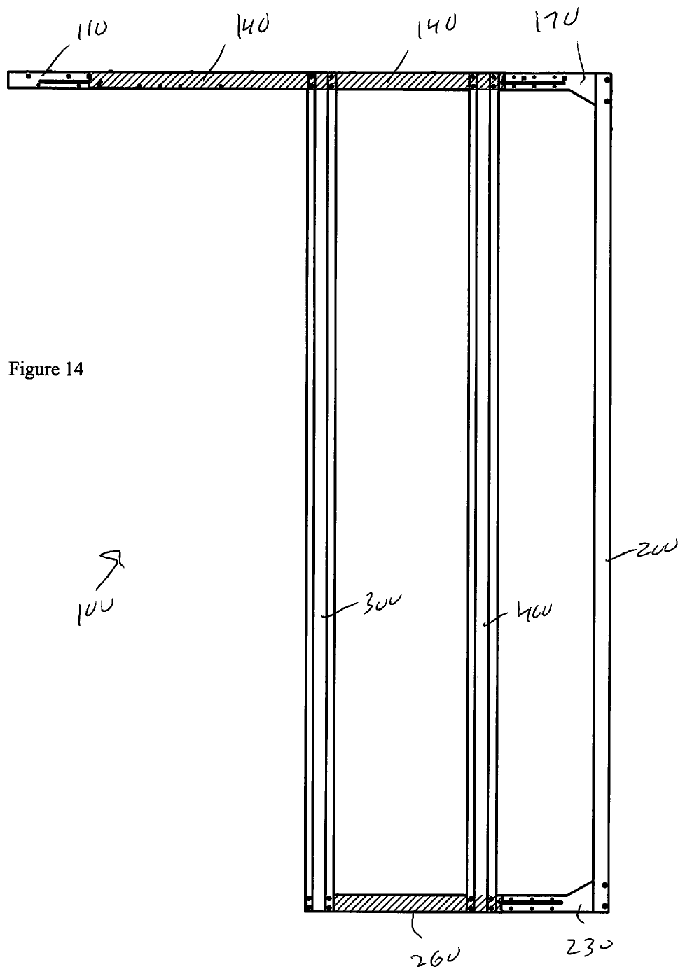

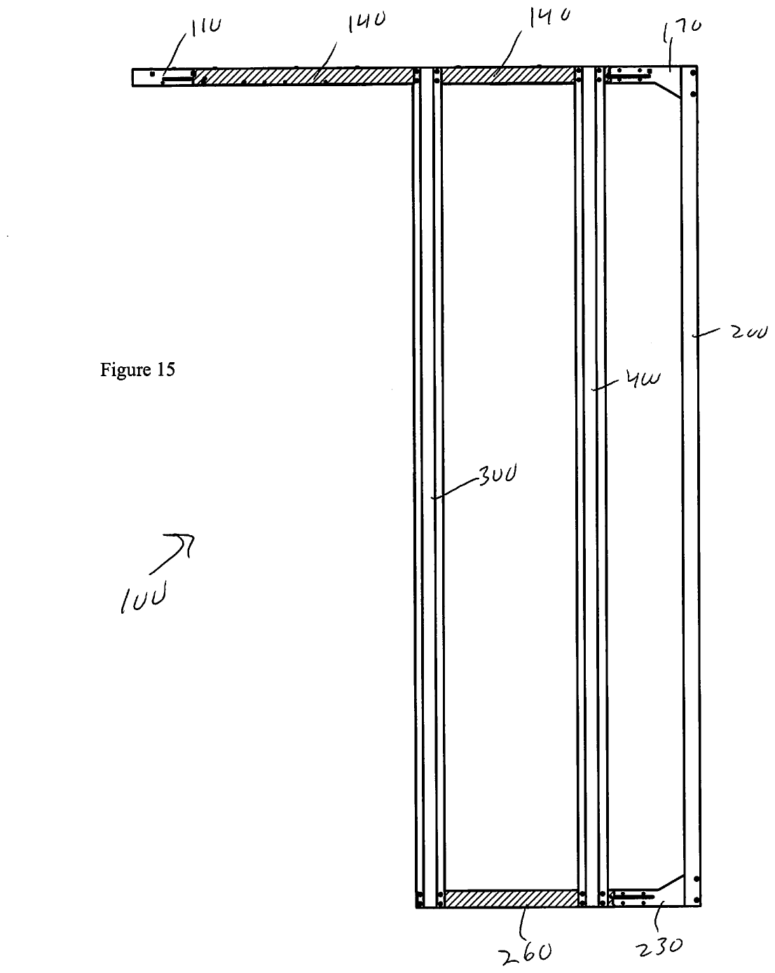

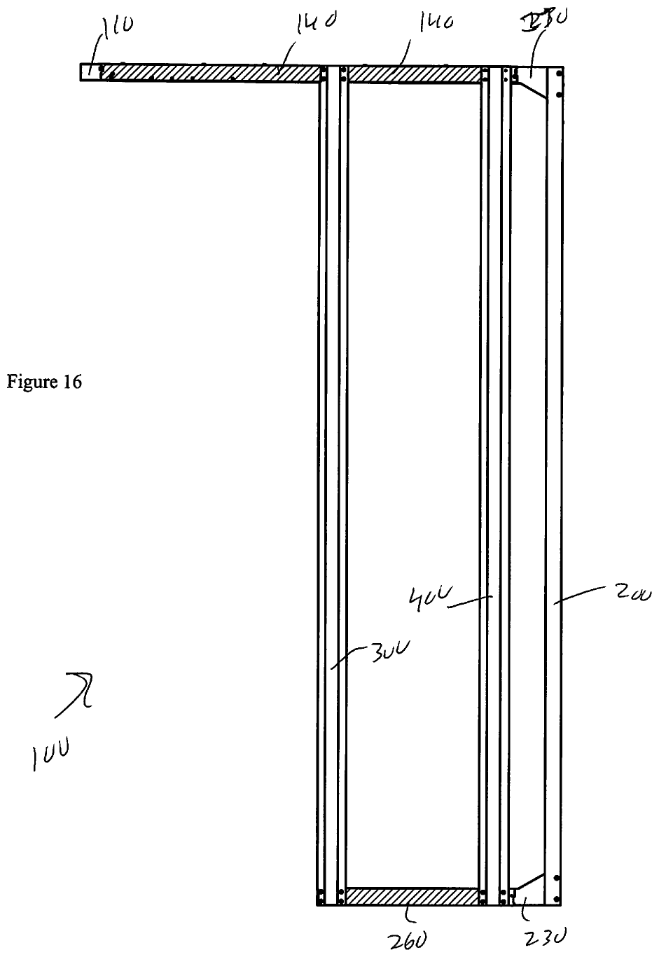

Preferably gaps or spaces are created between opposing uprights 300 and opposing uprights 400 to allow the secured pocket door to be slid between uprights 300 and 400. Where a smaller width pocket door is chosen, a cross bracket 450 can be secured to uprights 300 which serves as a stop member for how far the door can be slid in the door open position. In certain situations, without cross bracket 450 (see FIG. 12) secured to uprights 300 the pocket door may slid too far within the portion of frame 100 covered up or hidden within finished wall, and could become difficult to reach to pull out when the door is needed to be in an open position.

Uprights 300 and 400 can resemble hat channel 110 in cross-sectional shape (See FIGS. 26 and 28), with the noted exception that uprights 300 can be provided with an extra 90 degree bend to provide for a clean edge 330 for drywall to go against and also for an installer (i.e. trim carpenter) to fasten trim wood to. Uprights 300 and 400 create the wall cavity to store the pocket door when the door is slid within the wall to allow passage through the walkthrough/doorway.

Flanges 124 and 126 of hat channel 110 and similar flanges of hat channel member 146 of modified hat channel 140 can be provided for attaching the wood trim work that is typically provided around a pocket door.

Preferably both sides of the top portion of frame 100 (i.e. hat channel 110 with modified hat channel 140 and modified hat channel 140 with U-channel 170) are adjusted, and preferably adjusted equally. The front part of the door frame (i.e. having the walkthrough doorway), which shows the door when the door is in a closed position and blocks the walkthrough doorway, preferably can have the same width as the back part of the door frame, which stores away the door inside the wall cavity when the door is in an open position to allow passage through the walkthrough doorway.

Preferably, a plurality of pem nuts, nuts or other fasteners or self-clinching fasteners (collectively “fasteners” 500) can be disposed at least some and preferably all of the disclosed and described apertures that will receive screw, bolts, etc. for securement. In one non-limiting embodiment, the pem nuts can be compressed into the desired apertures of the metal parts, such as, but not limited to, the use of a pneumatic insertion machine.

The sliding connections between hat channel 110 and modified hat channel 140, modified hat channel 140 and U-channel 170, and U-channel 230 and U-channel 260 are preferably permanent connections and prevented from being pulled out through the use of a rivet/protrusion with an outer copper line. Additionally, the pivotable connections between the U-channels at each end of the extended U-channel 200 can also be preferably a permanent connection.

Though not preferred, it is also within the scope of the disclosure, to provide a novel frame 100 which is provided in a single specific door width size, while still retaining its folding/pivoting characteristics for compact transport and/or still constructed from a preferred rust proof metal material.

References to U-shaped herein also include substantially U-shaped.

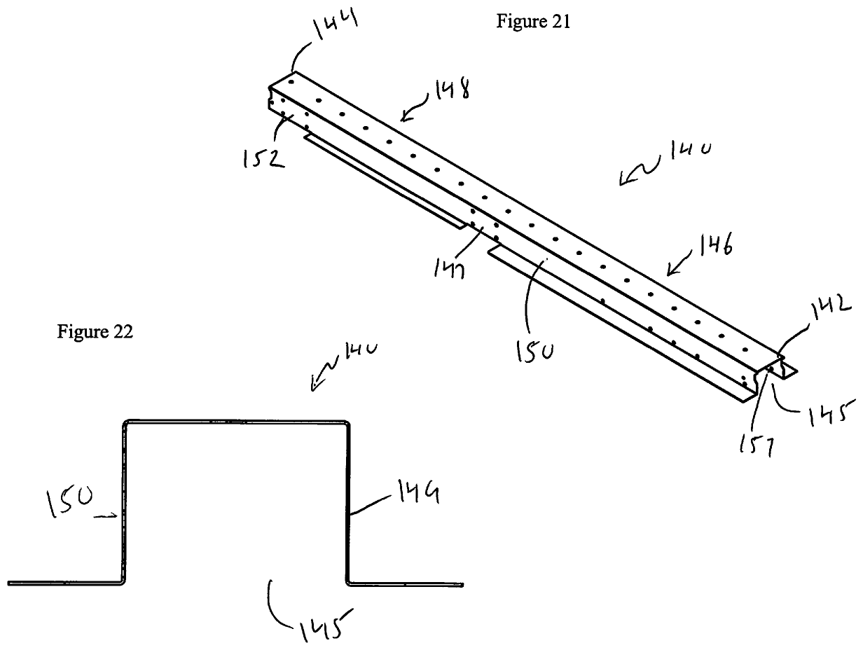

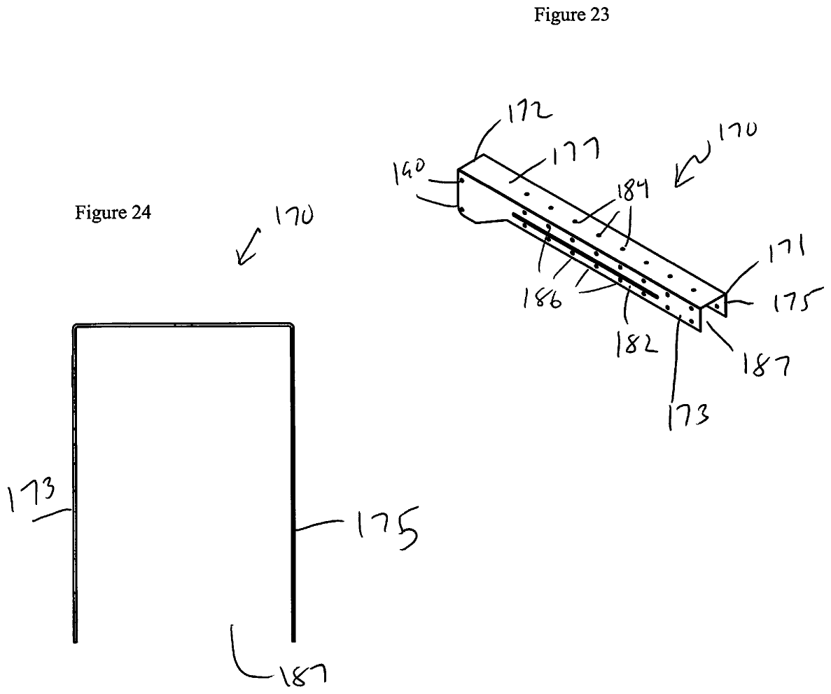

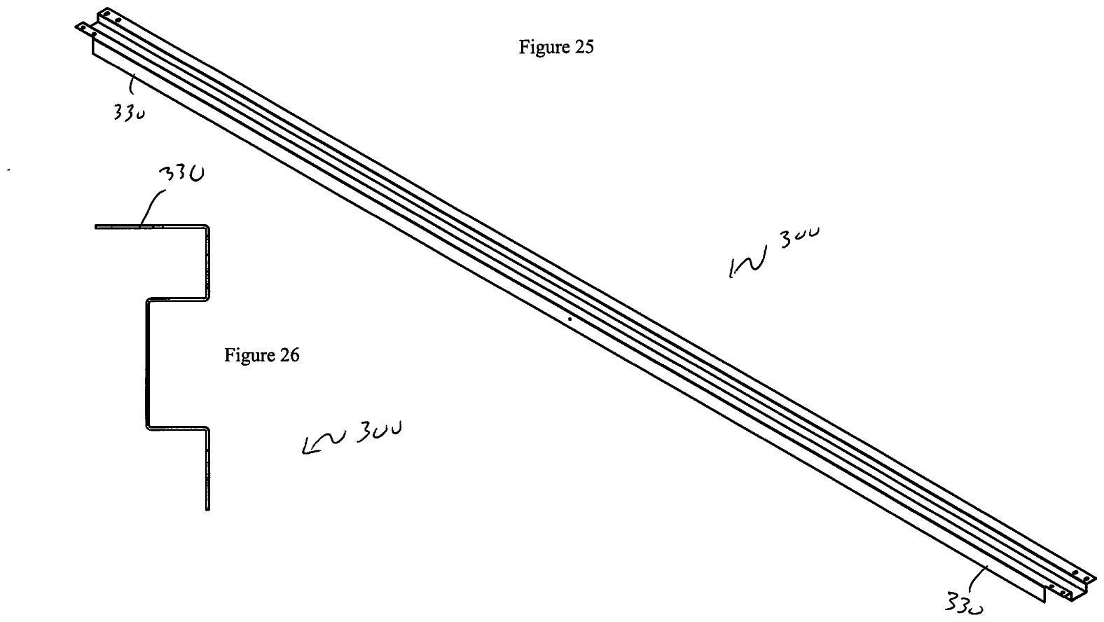

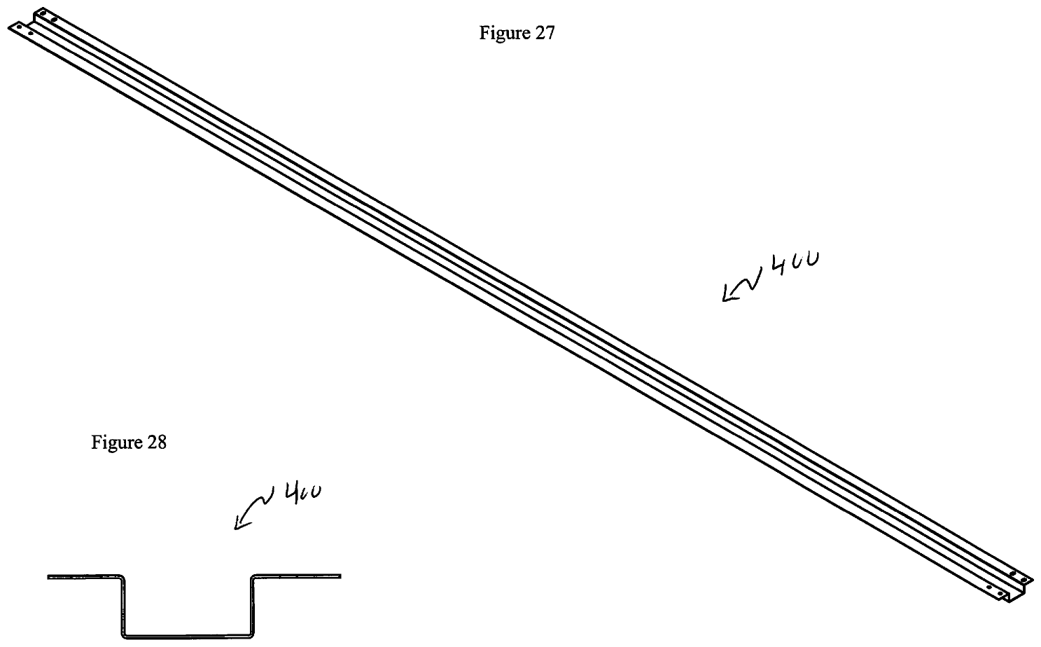

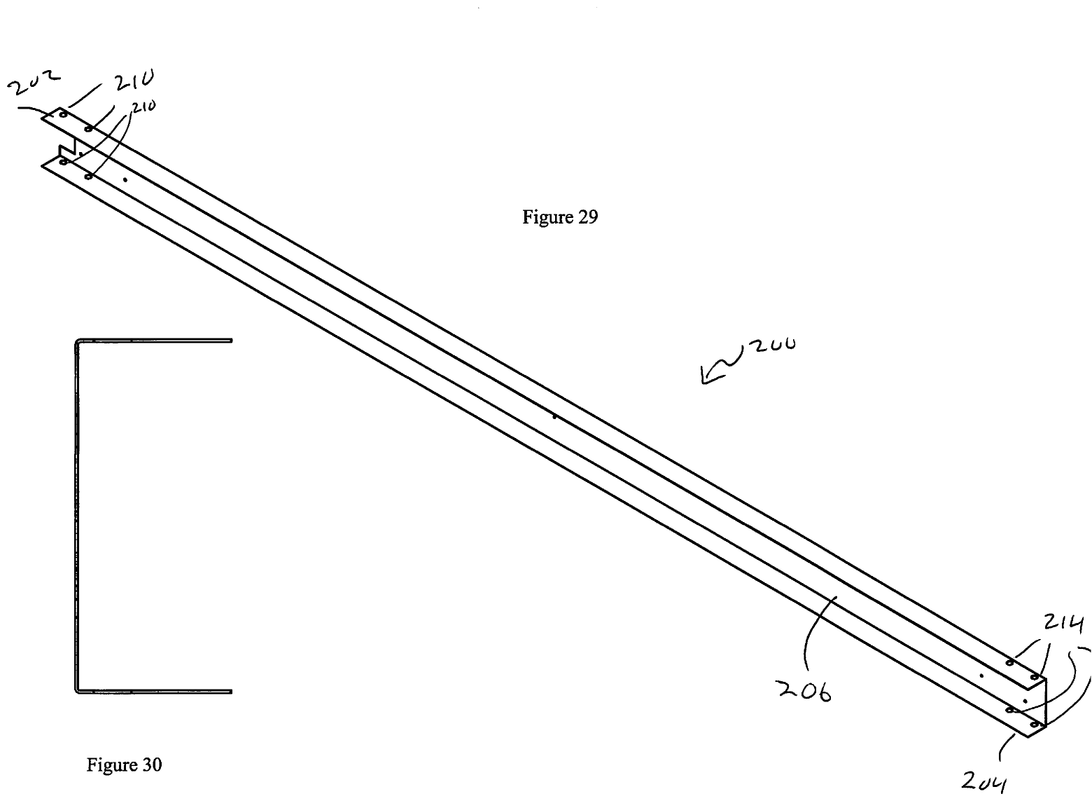

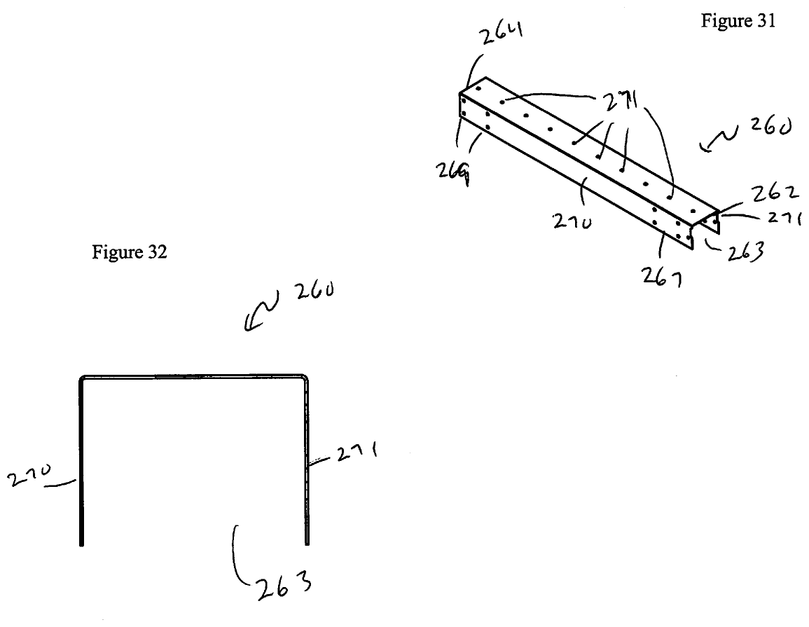

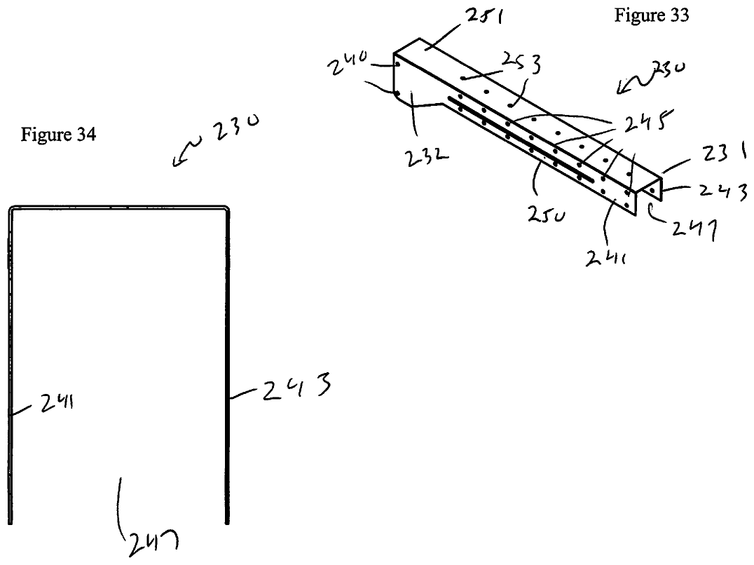

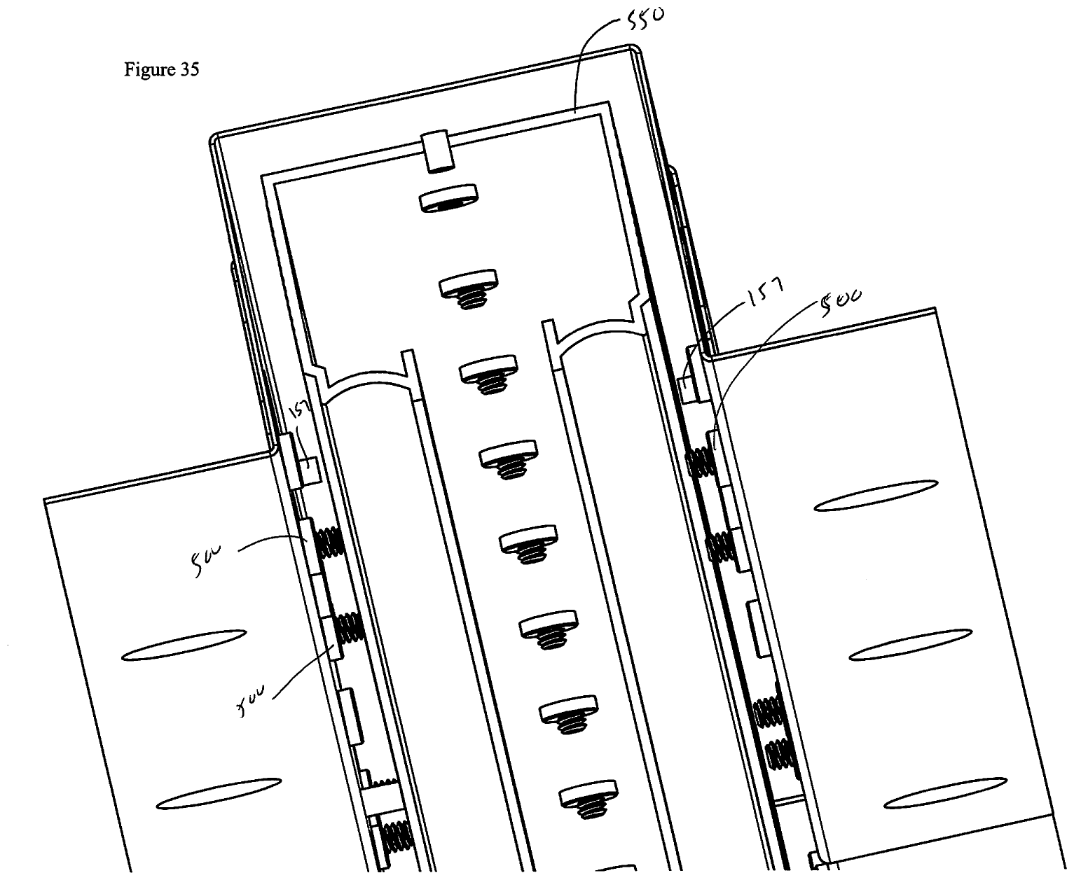

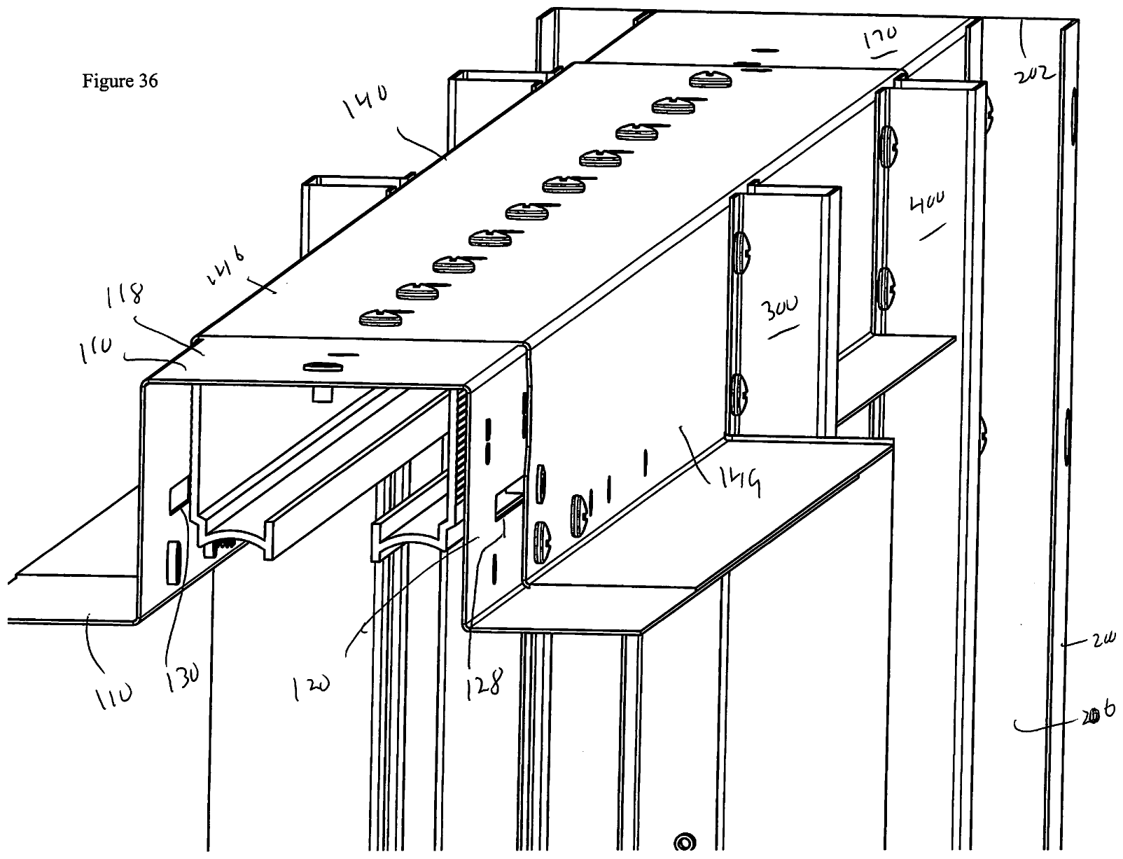

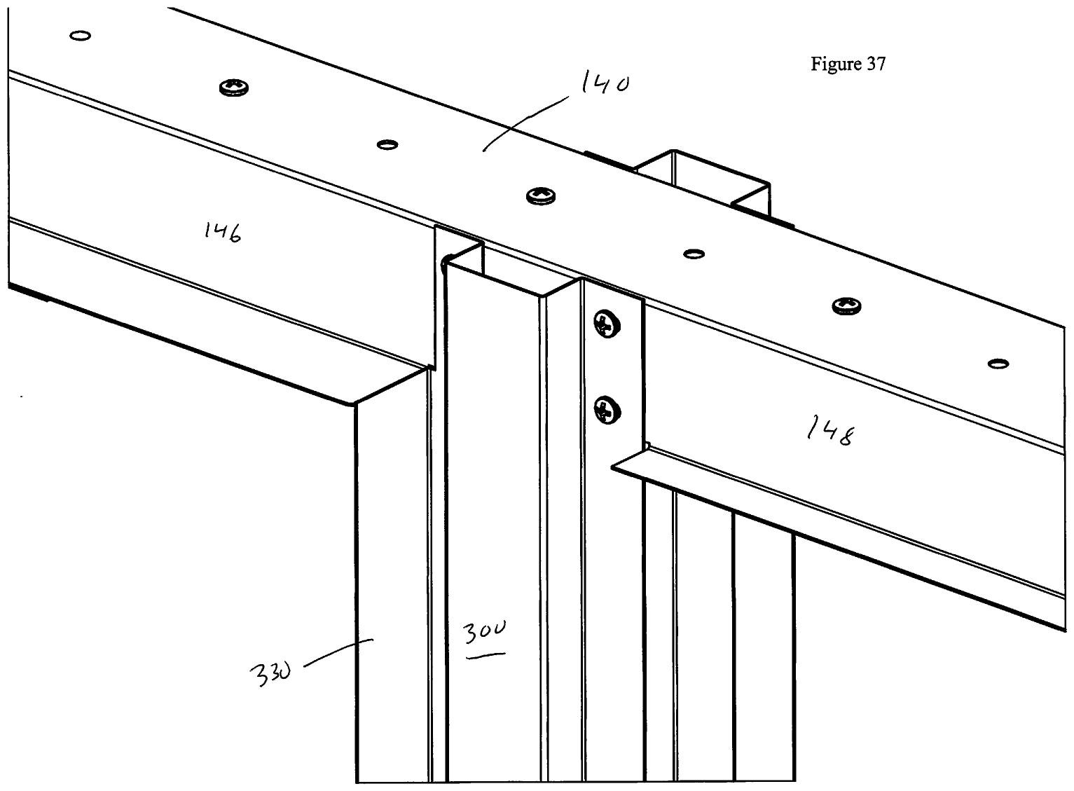

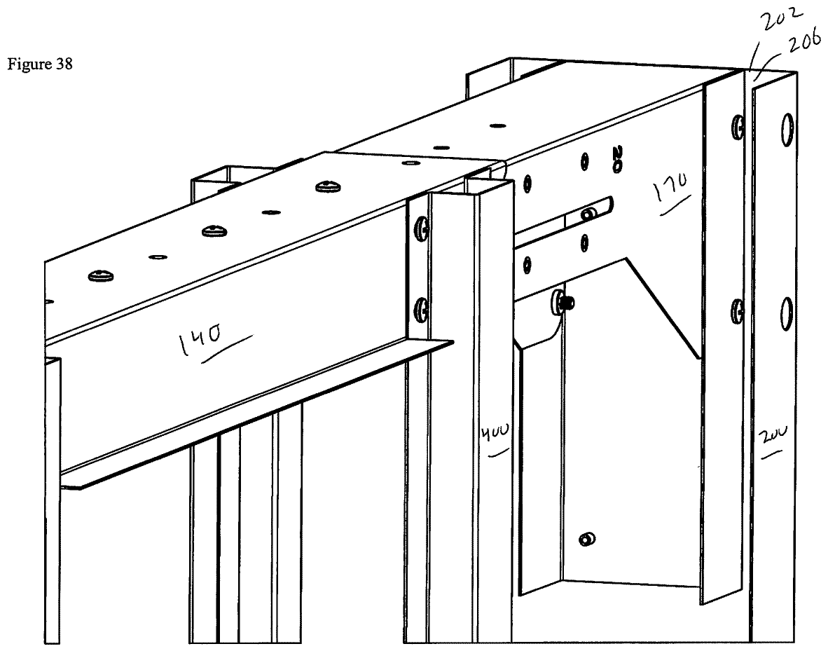

The inner protrusions or rivets described herein, but not seen in the drawings, for creating the sliding relationship between hat channel 110 and modified hat channel 140, modified hat channel 140 and U-channel 170, and U-channel 230 and U-channel 260, can be similar to the protrusion/rivet that is viewable in the perspective view of modified hat channel 140 in FIG. 21 and the protrusion/rivet shown in FIG. 21 is incorporated by reference with respect to the other described protrusions/rivets.

Features or characteristics described for one of the parts/components for frame 100 herein can also be used with other parts/components of frame 100.

Conventional door tracks, wheels, hardware, door guides, locks, handles, etc. can be installed onto the various components/members of pocket door frame 100 or the pocket door. Additionally, pocket door frame 100 can be used with various types of sliding doors constructed from various conventional door materials and/or with various types of sliding door tracks and all are considered within the scope of the disclosure.

Though not considered limiting the described parts/components of frame 100 and uprights 300 and 400 can be constructed from a metal material and preferably a galvanized steel with an anti-corrosive coating. The material can be a galvanized steel with an anti-corrosive coating of better than 6-40. The thickness for the parts/components is not considered limited to any specific dimensions and in a non-limiting embodiment can range from 0.028″ to 0.033″, though other ranges and other dimensions can be used and are considered within the scope of the disclosure. Other materials can also be used for some or all of the various described parts. Preferably, the material selected for the parts overcomes some or all of the above noted problems with using wooden frames and also does not have issues with corrosion or rust.

It should be understood that the exemplary embodiments described herein should be considered in a descriptive sense only and not for purposes of limitation. Descriptions of features or aspects within each embodiment should typically be considered as available for other similar features or aspects in other embodiments. While one or more embodiments have been described with reference to the Figures, it will be understood by those of ordinary skill in the art that various changes in form and details may be made therein without departing from their spirit and scope.

All components/parts of the described pocket door frame, mechanical connection methods, materials, values, dimensions, sizes, etc. discussed above or shown in the drawings, if any, are merely by way of example and are not considered limiting and other component(s)/parts, mechanical connection methods, materials, uses, values, dimensions, sizes, etc. can be chosen and used and all are considered within the scope of the disclosure.

Dimensions of certain parts as shown in the drawings may have been modified and/or exaggerated for the purpose of clarity of illustration and are not considered limiting.

All numbers, values, amounts, dimensions, temperatures, etc. (“Values”), if any, are provided by way of example and not considered limiting, and it is also within the scope of the disclosure to use higher and/or lower Values with the disclosed novel system/platform and method.

Unless feature(s), part(s), component(s), characteristic(s) or function(s) described in the specification or shown in the drawings for a claim element, claim step or claim term specifically appear in the claim with the claim element, claim step or claim term, then the inventor does not consider such feature(s), part(s), component(s), characteristic(s) or function(s) to be included for the claim element, claim step or claim term in the claim when and if the claim element, claim step or claim term is interpreted or construed. Similarly, with respect to any “means for” elements in the claims, the inventor considers such language to require only the minimal amount of features, components, steps, or parts from the specification to achieve the function of the “means for” language and not all of the features, components, steps or parts describe in the specification that are related to the function of the “means for” language.

The benefits, advantages, solutions to problems, and any element(s) that may cause any benefit, advantage, or solution to occur or become more pronounced are not to be construed as a critical, required, or essential features or elements of any or all the claims.

While the disclosure has been described in certain terms and has disclosed certain embodiments or modifications, persons skilled in the art who have acquainted themselves with the disclosure, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

What is claimed is:

1. A foldable pocket door frame, comprising:
an elongated frame member having a first end and a second end;
a top frame member pivotally connected to or near the first end of the elongated frame member; and
a bottom frame member pivotally connected to or near the second end of the elongated frame member;
wherein in transit the top frame member is pivoted or folded inward and partially received by or within the elongated frame member and bottom frame member is pivoted or folded inward and partially received by or within the elongated frame member.

2. The foldable pocket door frame of claim 1 further comprising a first upright member having a first end and a second end and a second upright member having a first end and a second end.

3. The foldable pocket door frame of claim 2 wherein when the pocket door frame is unfolded and assembled the first end of the first upright member is secured to or near an outer end of the bottom frame member and the second end of the first upright member is secured to an intermediate point of the top frame member and the first end of the second upright member is secured to the bottom frame member at a point between the first upright member and the elongated frame member and the second end of the second upright member is secured to the top member at a point between the first upright member and the elongated frame member.

4. The foldable pocket door frame of claim 1 wherein the top frame member comprises
a first horizontal portion having an insertion end;
a second horizontal portion having a first end that receives the insertion end of the first horizontal portion; and
a third horizontal portion having an insertion end that is received within a second end of the second horizontal portion.

5. The foldable pocket door frame of claim 2 wherein the top frame member, the elongated frame member, the bottom frame member, the first upright member and the second upright member are constructed from a galvanized steel material having an anti-corrosion coating.

6. The foldable pocket door frame of claim 4 wherein a position of the first horizontal portion with respect to second horizontal portion is slidably adjustable and a position of the third horizontal portion with the respect to the second horizontal portion is slidably adjustable depending on a width of a pocket door to be used with the pocket door frame.

7. The foldable pocket door frame of claim 6 wherein the first horizontal portion is permanently and slidably secured to the second horizontal portion and the third horizontal portion is permanently and slidably secured to the second horizontal portion.

8. The foldable pocket door frame of claim 7 wherein the first horizontal portion, the second horizontal portion and the third horizontal portion defining an inner channel which is adapted to receive a top track for the securing the pocket door to the pocket door frame and for sliding the pocket door back and forth along the inner channel.

9. The foldable pocket door frame of claim 8 wherein the inner channel having a U-shaped cross-sectional shape.

10. The foldable pocket door frame of claim 1 wherein the bottom frame member comprising;
a fourth horizontal portion having an insertion end; and
a fifth horizontal portion having a first end that receives the insertion end of the fourth horizontal member.

11. The foldable pocket door frame of claim 10 wherein a position of the fourth horizontal portion with respect to fifth horizontal portion is slidably adjustable depending on a width of a pocket door to be used with the pocket door frame.

12. The foldable pocket door frame of claim 11 wherein the fourth horizontal portion is permanently and slidably secured to the fifth horizontal portion.

13. A foldable and adjustable pocket door frame and plurality of uprights assembly, comprising:
a first member having a first end and a second end and having a first side wall, a second side wall and a top wall defining a channel extending from the first end to the second end, the first side wall defining a first slot extending along a portion of the first side wall, the first side wall having a plurality of apertures and a plurality guides, each aperture of the plurality of apertures and each guide of the plurality of guides associated with a width for a pocket door to be used with the foldable pocket door frame;
a second member having a first end and a second and having a first side wall, a second side wall and a top wall defining a channel extending from the first end to the second end, the second member having an inner protrusion extending inward within the channel of the second member at or near the first end of the second member that is received within the first slot of the first member, wherein the first side wall of the second member having a first plurality of apertures and at least one of the apertures of the first side wall of the first member is aligned with at least one aperture of the first side wall of the second member to allow the apertures to receive a fastening member to maintain the width positional relationship between the first member and the second member in use, the first sidewall of the second member having a second plurality of apertures at or near the second end of the second member, and the a third plurality of apertures disposed between the first plurality of apertures and the second plurality of apertures of the second member,
a third member having a first end and second end and having a first side wall, a second side wall and a top wall defining a channel extending from the first end to the second end, the first side wall of the third member defining a first slot extending along a portion of the first side wall of the third member, the first side wall of the third member having a plurality of apertures with the apertures associated with differing widths for the pocket door to be used with the foldable pocket door frame;
wherein the second member having a second inner protrusion extending inward within the channel of the second member at or near the second end of the second member that is received within the first slot of the third member, wherein at least some of the second plurality of apertures and at least one of the apertures of the first side wall of the third member are aligned to allow the apertures to receive a fastening member to maintain the width positional relationship between the third member and the second member in use;
a fourth member having a first end and a second end and defining a channel extending between the first end and the second end, the second end of the third member pivotally secured to the fourth member at or near the first end of the fourth member,
a fifth member having a first end and second end and having a first side wall, a second side wall and a top wall defining a channel extending from the first end to the second end, the first side wall of the fifth member defining a first slot extending along a portion of the first side wall of the fifth member, the first side wall of the fifth member having a plurality of apertures with the apertures associated with differing widths for the pocket door to be used with the foldable pocket door frame, the second end of the fifth member pivotally secured to the fourth member at or near the second end of the fourth member;
a sixth member having a first end and second end and having a first side wall, a second side wall and a top wall defining a channel extending from the first end to the second end, the sixth member having an inner protrusion extending inward within the channel of the sixth member at or near the first end of the sixth member that is received within the first slot of the fifth member, the first sidewall of the sixth member having a first plurality of apertures at or near the first end of the sixth member and a second plurality of apertures disposed at the second end of the sixth, wherein at least some of the first plurality of apertures of the sixth member and at least one of the apertures of the first side wall of the fifth member are aligned to allow the apertures to receive a fastening member to maintain the width positional relationship between the fifth member and the sixth member in use;
a first upright member having a first end and a second end, the first end of the first upright member secured to an intermediate point of the first sidewall of the second member and the second end of the first upright member secured at or near a second end of the first sidewall of the sixth member; and
a second upright member having a first end and a second end, the first end of the first upright member secured to the second end of the first sidewall of the second member and the second end of the second upright member secured at or near a first end of the first sidewall of the sixth member;
wherein in a collapsed configuration and prior to securing the first upright member and the second upright member the third member is folded inward and at least partially received within the channel of the fourth member which also causes the first member and the second member to also be partially received within the channel of the fourth member and the fifth member is folded inward and at least partially received within the channel of the fourth member which also causes the sixth member to also be partially received within the channel of the fourth member.

14. The foldable and adjustable pocket door frame of claim 13 the first member, the second member, the third member, the fourth member, the fifth member, the sixth member, the first upright member and the second upright member are constructed from a galvanized steel material having an anti-corrosion coating.

15. The foldable and adjustable pocket door frame of claim 13 wherein the first member is permanently and slidably secured to the second member and the third member is permanently and slidably secured to the second member.

16. The foldable and adjustable pocket door frame of claim 13 wherein the fifth member is permanently and slidably secured to the sixth member.

17. The foldable and adjustable pocket door frame of claim 13 wherein the channel of the first member, the channel of the second member, the channel of the third member, the channel of the fourth member, the channel of the fifth member and the channel of the sixth member all have a U-shaped cross-sectional shape.

18. The foldable and adjustable pocket door frame of claim 13 further comprising:
a third upright member having a first end and a second end, the first end of the third upright member secured to an intermediate point of the second sidewall of the second member and the second end of the third upright member secured at or near a second end of the second sidewall of the sixth member; and
a fourth upright member having a first end and a second end, the first end of the fourth upright member secured to the second end of the second sidewall of the second member and the second end of the fourth upright member secured at or near a first end of the second sidewall of the sixth member;
wherein the first upright member and the third upright member defining a first space therebetween and the second upright member and the fourth upright member defining a second space therebetween for receipt of a pocket door attached to the pocket door frame when the pocket door is withdrawn within a wall cavity that the upright members are disposed in when the pocket door frame is installed.

19. The foldable and adjustable pocket door frame of claim 13 wherein the first member having a first flange extending outward from the first sidewall of the first member from a first end to a second end of the first member and the second member having a second flange extending outward from at least a portion of the first sidewall of the second member beginning from the first end of the second member.

20. The foldable and adjustable pocket of claim 19 wherein an opposite end of the second flange terminates prior to a location of the third plurality of apertures in the first sidewall of the second member.
